(19) United States
(12) Patent Application Publication
(10) Pub. No.: US 2012/0054986 A1
(43) Pub. Date: Mar. 8, 2012

(54) PAINTBRUSH GRIP COVER

(76) Inventor: David Wood, Mammoth Spring, AR (US)

(21) Appl. No.: 12/876,502

(22) Filed: Sep. 7, 2010

(51) Int. Cl. B25G 1/10

(52) U.S. Cl. 16/430; 16/110.1

(57) ABSTRACT

A paintbrush gripping device comprising an elongated body embodied in a tubular shape, an accepting opening at an upper portion of the elongated body, a closed base at a lower end of the elongated body opposite to the accepting opening, and a row of slots extending along a length of the elongated body wherein a handle of a paintbrush is first inserted into the accepting opening, then slides through the elongated body to stop at the closed base, and wherein the row of slots expands the elongated body to enable a variety of widths of the handle to fit within the paintbrush gripping device thus giving the handle a wider diameter.

### BACKGROUND OF THE INVENTION

1. Field of the Invention

The present invention relates to a cover for a paintbrush handle to provide a wider diameter to the handle and to enable a person with difficulty holding conventional paintbrushes a way to more easily and comfortably grip the paintbrush.

2. Description of Related Art

A favorite pastime for many individuals is to express themselves artistically whether it be through drawing, painting or even sculpting. While many times painting is considered a hobby or activity, many people are able to make a living by turning painting into their career. Many supplies and tools are used for painting, but one tool stands out above the rest; the paintbrush. Paintbrushes are available in a variety of lengths, widths, diameters, bristle types, bristle textures and shapes. Most art supply stores provide an entire paintbrush section to allow painters to select their favorite style brushes or brushes specific to their painting needs.

A sad reality is when some artists are no longer able to paint either due to a hand disability, arthritis or carpal tunnel syndrome. All of these conditions may make gripping or maneuvering a paintbrush difficult or even impossible. Most conventional paintbrushes are small in diameter, consequently causing pain or discomfort when a person with hand problems holds onto the handle for a prolonged period of time. In some cases, the person's hand may not be capable of closing all the way thus the handle, thus causing the paintbrush to slide or fall out of their hand. For the professional artist loss of hand dexterity and mobility symbolizes the end of their careers.

It would be desirable in the art to provide a device to expand the width of a paintbrush to enable a person with hand problems to more easily grip the handle. It would also be beneficial to have a paintbrush gripping device which easily fits multiple paintbrush diameters.

### SUMMARY OF THE INVENTION

The present invention provides a paintbrush gripping device comprising an elongated body embodied in a tubular shape, an accepting opening at an upper portion of the elongated body, a closed base at a lower end of the elongated body opposite to the accepting opening, and a row of slots extending along a length of the elongated body wherein a handle of a paintbrush is first inserted into the accepting opening, then slides through the elongated body to stop at the closed base, and wherein the row of slots expands the elongated body to enable a variety of widths of the handle to fit within the paintbrush gripping device thus giving the handle a wider diameter.

Another object of the present invention is to provide a flat edge for the elongated body to permit the paintbrush gripping device to rest on a table or counter without rolling off.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a paintbrush grip cover in accordance with an exemplary embodiment of the present invention; and

FIG. 2 depicts a perspective view of a paintbrush grip cover in accordance with an alternative embodiment of the present invention.

Like reference numerals refer to like parts throughout the description of several views of the drawings.

### DETAILED DESCRIPTION OF THE DRAWINGS

The present invention relates to a paintbrush gripping device as a way to widen the diameter of paint brushes. The paintbrush gripping device provides a slip on cover for a paintbrush handle so that the handle is easier and more comfortable to hold especially for those individuals with hand, finger or joint problems who may be unable to grip a conventional paintbrush. A single gripping device or paintbrush cover may fit around a variety of paintbrush handles, allowing a person to transfer the cover from one paintbrush to another. The paintbrush cover may be made from a soft foam material to easily slide along a handle while providing a comfortable grip for the user. With the benefits of a wider diameter and soft grip, individuals with hand problems may continue to express themselves artistically without the pain or difficulty normally suffered while painting.

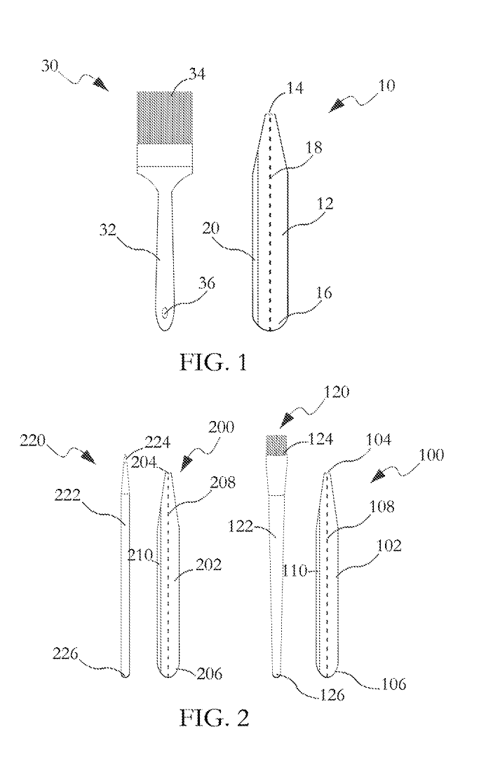

Tuning now descriptively to the drawings, referring to FIG. 1, a perspective view of a paintbrush grip cover (10) in accordance with an exemplary embodiment of the present invention. The paintbrush grip cover (10) or paintbrush gripping device includes an elongated body (12), an accepting opening (14) and a closed base (16). The elongated body (12) is a hollow tube or casing. The accepting opening (14) is at one end of the elongated body (12), and an opposite end is the closed base (16). The accepting opening (14) may be tapered (as shown) for a tight fit against a handle (32) of a paintbrush (30) or blunt for a looser grip against the handle. The closed base (16) is may be curved (as shown) or blunt depending on the preferences of a designer. The handle (32) of the paintbrush (30) may slide into the accepting opening (14), and continue down until a lower end (36) of the paintbrush (30) meets the closed base (16). Along the elongated body (12) may be a row of slots (18) or slits. The row of slots (18) may enable the elongated body (12) to expand to accept differing paintbrush handle widths. Also, along the length of the elongated body (12) may be a flat edge (20). The flat edge (20) may enable the paintbrush grip cover (10) to rest on a table or counter without rolling.

Referring to FIG. 2, a perspective view of the paintbrush grip cover (100 and 200) is shown in accordance with an alternative embodiment of the present invention. The paintbrush grip cover (100) may cover a medium sized paintbrush (120) fitting brushes (120) 1 inch wide, whereas the paintbrush grip cover (200) may fit a small paintbrush (220) like an artist brush or detail brush. The paintbrush grip cover (100) (shown in FIG. 1) may fit a large paintbrush (30), such as 1½-3 inches brushes. The three general sizes of paintbrush grip covers (10, 100 and 200) may accommodate a wide variety of paintbrushes because the row of slots (18, 108 and 208) expanding to accept the various paintbrush handle (32, 122 and 222) widths.

Accordingly, the paintbrush grip covers may be made from a soft foam or sponge material, neoprene, or another soft gripping material flexible enough to stretch yet return to its original shape. The material used to comprise the paintbrush grip cover may allow the paintbrush handle to easily slide while providing a wider, comfortable grip for a user. By providing a wider grip around the paintbrush handle a person with difficulty holding a narrow handle may easily grip and use the paintbrush when the paintbrush grip cover is attached. On the outside of the elongated body may be a gripping surface to give the user a better surface to hold onto the handle. The gripping surface may be rubberized so that the paintbrush gripping device has greater textile support in the user's hand. The paintbrush gripping cover may grant individuals with hand deformations, manual dexterity problems or hand disabilities a way to grip and use a conventional paintbrush without feeling the pain or discomfort normally felt during prolonged painting sessions.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A paintbrush gripping device comprising:
an elongated body embodied in a tubular shape;
an accepting opening at an upper portion of said elongated body;
a closed base at a lower end of said elongated body opposite to said accepting opening; and
a row of slots extending along a length of said elongated body wherein a handle of a paintbrush is first inserted into said accepting opening then slides through said elongated body to stop at said closed base, and wherein said row of slots expands said elongated body to enable a variety of widths of said handle to fit within said paintbrush gripping device thus giving said handle a wider diameter.

2. The paintbrush gripping device of claim 1, wherein said elongated body includes a flat edge to allow said paintbrush gripping device to rest on a table without rolling.

3. The paintbrush gripping device of claim 1, wherein said elongated body is made from a soft foam material.

4. The paintbrush gripping device of claim 1, wherein said elongated body is made from a neoprene material.

5. The paintbrush gripping device of claim 1, wherein said elongated body includes an outer gripping surface to enable a person to better grip said paintbrush.
